(19) United States
(12) Patent Application Publication
(10) Pub. No.: US 2013/0194405 A1
(43) Pub. Date: Aug. 1, 2013

(54) CAMERA HEAD AND IMAGING APPARATUS

(71) Applicants: Kei TASHIRO, Oume-shi (JP); Takatoshi KAMEI, Oume-shi (JP)

(72) Inventors: Kei TASHIRO, Oume-shi (JP); Takatoshi KAMEI, Oume-shi (JP)

(21) Appl. No.: 13/570,007

(22) Filed: Aug. 8, 2012

(30) Foreign Application Priority Data
Jan. 31, 2012 (JP) 2012-019339

(51) Int. Cl. H04N 7/18

(52) U.S. Cl. 348/76; 348/E07.085

(57) ABSTRACT

There is provided a conductive supporting member provided to be electrically brought into contact with a shielding part of a cable bundle, and supporting the cable bundle. Further, there is provided a supporting member holding part provided to support a circuit board controlling an imaging element, and holding the conductive supporting member connected to a part of cables of the cable bundle. Further, there is provided a conductive coating member coated on a part of the supporting member and a part of the supporting member holding part.

### CROSS-REFERENCE TO RELATED APPLICATION

This application is based upon and claims the benefit of priority from the prior Japanese Patent Application No. 2012-019339, filed on Jan. 31, 2012; the entire contents of which are incorporated herein by reference.

### FIELD

Embodiments described herein relate generally to a camera head and an imaging apparatus.

### BACKGROUND

In recent years, medical endoscope cameras have been widely used. Among the medical endoscope cameras, there is one that uses an optical fiber and a CCD, for instance. As the medical endoscope camera, one of head separation type in which an imaging unit (camera head) and a control unit (CCU: camera control unit) are separated, is generally employed.

Further, regarding an endoscope camera of head separation type being a type of inserting a camera head into a body, a reduction in size of the camera head is desired for reducing a burden on a patient. For this reason, it is a task to reduce the size of the camera head.

### BRIEF DESCRIPTION OF THE DRAWINGS

FIG. 1 is a configuration diagram of an imaging apparatus according to an embodiment.

FIG. 2A and FIG. 2B are configuration diagrams of a camera head according to a comparative example.

FIG. 3A and FIG. 3B are configuration diagrams of a camera head according to the embodiment.

FIG. 4A is a sectional diagram taken along A-A in FIG. 3B.

FIG. 4B is a sectional diagram taken along B-B in FIG. 3B.

FIG. 5 is a configuration diagram of a supporting member according to the embodiment.

FIG. 6A to FIG. 6C are diagrams illustrating examples of mounting method of the camera head according to the embodiment.

### DETAILED DESCRIPTION

Hereinafter, an embodiment will be described with reference to the drawings.

A camera head includes a conductive supporting member provided to be electrically brought into contact with a shielding part of a cable bundle, and supporting the cable bundle. Further, the camera head includes a supporting member holding part provided to support a circuit board controlling an imaging element, and holding the conductive supporting member connected to a part of cables of the cable bundle. Furthermore, the camera head includes a conductive coating member coated on a part of the supporting member and a part of the supporting member holding part.

An endoscope generally means a medical endoscope. The medical endoscope is mainly used for observing an inside of a human body. Further, the endoscope generally has an optical system built in its main body, and by inserting a tip thereof into a body of a patient, an image of the inner part (affected part) can be watched at hand. Further, there are endoscopes with a general elongate shape or of capsule type. Note that the endoscopes are used, not only in a medical field but also for observation of an inner part of a structure which is difficult to be directly observed, finding of disaster victim when a disaster occurs, and the like.

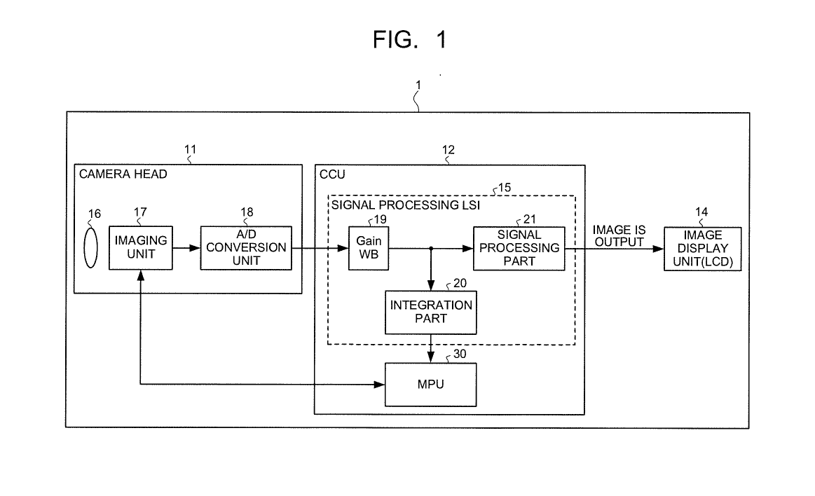

FIG. 1 is a block diagram illustrating a configuration of an imaging apparatus of the embodiment. A camera head 11 includes a lens 16, an imaging unit (electronic shutter) 17, and an A/D conversion unit 18. A CCU (camera control unit) 12 includes, for example, a signal processing section (signal processing LSI) 15.

The signal processing section (signal processing LSI) 15 includes a linear processing part 19 performing processing for gain and white balance of image, and an integration part 20 integrating image data after being subjected to image processing in the linear processing part 19.

In the integration part 20, image signals after being subjected to the white balance processing are input. The integration part 20 integrates brightness levels of the input image signals. The integration part 20 outputs the integrated brightness level to an MPU 30.

The MPU 30 feedbacks the image data transmitted from the integration part 20 to a control of the imaging unit (electronic shutter) 17.

The signal processing section (signal processing LSI) 15 includes a signal processing part 21 performing signal processing on the image data after being subjected to the image processing in the linear processing part 19.

The signal processing part 21 performs non-linear processing of γ (gamma) correction, edge correction and the like, on the received image signal.

The image data from the signal processing part 21 is transmitted to an image display unit 14 such as an LCD, for example, and the image captured by the imaging unit (electronic shutter) 17 is displayed.

The MPU 30 is connected to the CCU (camera control unit) 12 and the signal processing section (signal processing LSI) 15, and controls the CCU 12 and the signal processing section 15.

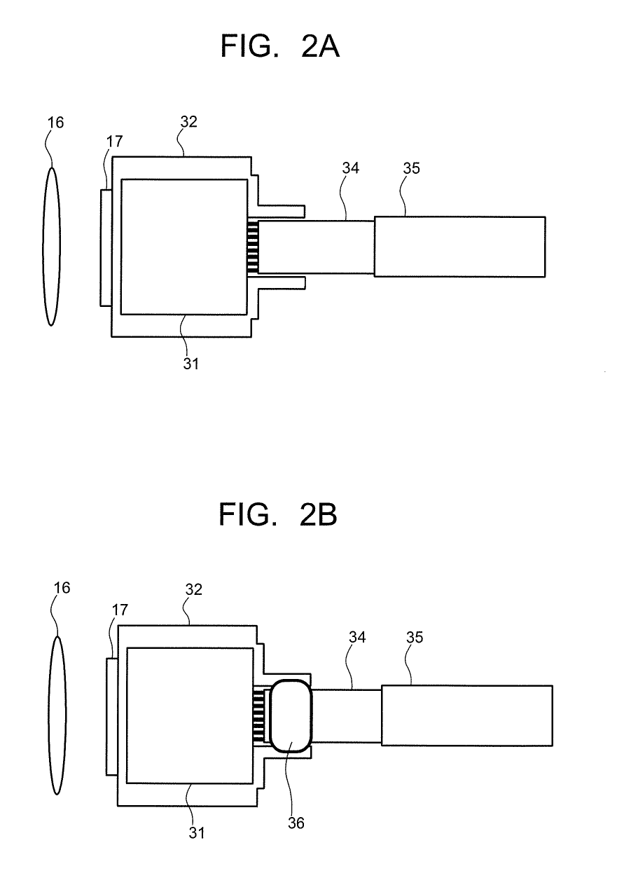

FIG. 2A and FIG. 2B are configuration diagrams of a camera head according to a comparative example.

As illustrated in FIG. 2A and FIG. 2B, a medical endoscope camera generally employs a configuration of head separation type in which an imaging unit and a control unit (CCU) are separated.

Further, when the endoscope camera is of a type of inserting the camera head into a body, there is a requirement for the reduction in size of the camera head for reducing a burden on a patient, for example.

Further, in order to reduce the size of the camera head, a configuration in which a cable is directly connected to a camera head board, is employed.

In this case, in order to securely fix the cable and the camera head board and to securely realize electrical continuity (GND connection, for example) between the cable and the camera head board, a frame made of metal (metallic frame) excellent in conductivity is used, for example.

Further, in order to fix the metallic frame and a shielding part of the cable and to make them conduct, it is conceivable to use solder or conductive adhesion, for example.

However, when the solder is used for fixing the metallic frame and the shielding part of the cable, there is a problem that a jacket of the cable is melted by heat when performing the solder. Further, there is also a case where there arises a problem such that the solder soaks into a shielded line of the cable, resulting in that the cable becomes stiff. In order to solve these problems, a conductive adhesive is used, for example.

FIG. 2A and FIG. 2B illustrate a camera head in which a conductive adhesive 36 is used for fixing a metallic frame (supporting member holding part) 32 and a shielding part 34 of a cable. FIG. 2A illustrates a state before the metallic frame 32 and the shielding part 34 of the cable are adhered by the conductive adhesive 36. FIG. 2B illustrates a state where the metallic frame 32 and the shielding part 34 of the cable are fixed by using the conductive adhesive 36.

In this comparative example, the conductive adhesive 36 is coated on a contact portion between the metallic frame 32 and the shielding part 34 of the cable, to thereby securely fix the metallic frame 32 and the shielding part 34 of the cable and secure the continuity between the both.

The conductive adhesive 36 has a cure temperature lower than that of the solder, so that effects of suppressing the melting of the shielding part 34 of the cable and the like, the soakage into the shielded line and the like are improved.

However, in the configuration in which the conductive adhesive 36 is used to fix the metallic frame 32 and the shielding part 34 of the cable as above, when the cable is bent at the time of using the camera head, the shielding part 34 of the cable or the like is bent. Further, a stress due to the bending is applied to the conductive adhesive 36. For this reason, when the camera head is used for a long period of time and the like, there is a possibility that the conductive adhesive 36 is peeled off, resulting in that the strength, the continuity and the like between the fixed metallic frame 32 and shielding part 34 of the cable deteriorate.

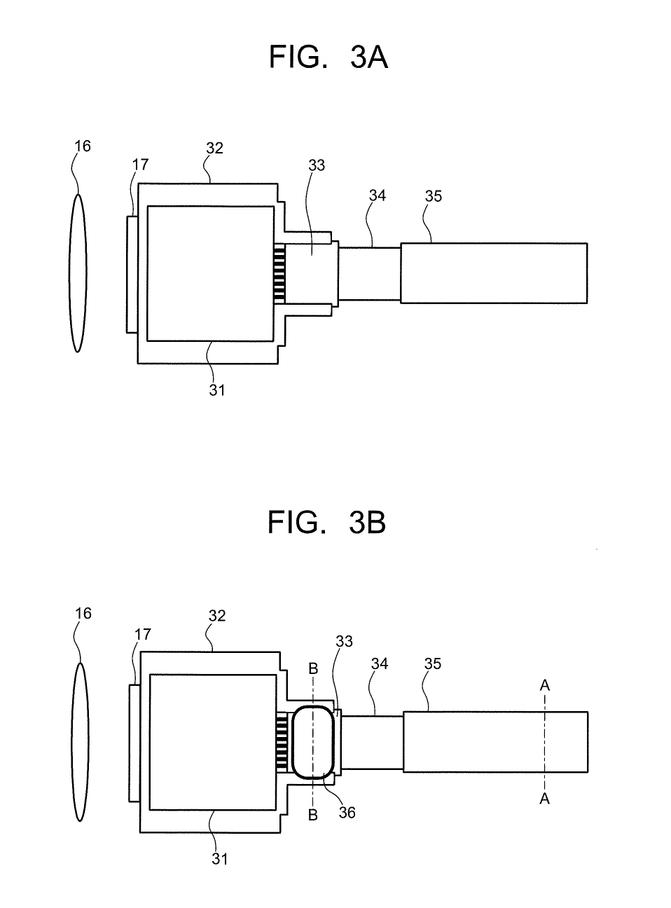

FIG. 3A and FIG. 3B are diagrams illustrating a configuration of a camera head used in an imaging apparatus of the embodiment. FIG. 3A illustrates a state before the conductive adhesive 36 is coated. FIG. 3B illustrates a state after the conductive adhesive 36 is coated.

As illustrated in FIG. 3A and FIG. 3B, the camera head used in the imaging apparatus of this embodiment includes, for example, the lens 16, the imaging element 17, a circuit board 31, the metallic frame 32, the conductive adhesive 36, a supporting member (crimping metal part) 33, and a cable bundle (the shielding part 34 of the cable bundle and a jacket 35 of the cable bundle).

Specifically, to the camera head illustrated in FIG. 3A and FIG. 3B, the supporting member 33 is added (compared to the comparative example illustrated in FIG. 2A and FIG. 2B).

From a point of view of the aforementioned conductivity and processability, the supporting member 33 can be formed of a metal including copper or a metal including brass. A shape of the supporting member 33 is desirable to be one with which the shielding part 34 of the cable bundle can be supported, such as a ring shape and a U shape.

Note that the supporting member 33 does not always have to strongly “crimp” the shielding part 34 of the cable bundle, and is only required to support the shielding part 34 of the cable bundle.

Further, the conductive adhesive 36 is an adhesive in which a material with good conductivity such as, for example, silver powder, copper powder, carbon fiber or the like is mixed.

Further, the imaging element 17 is directly soldered to the camera head board (circuit board 31) in this case. Note that although not particularly illustrated here, on the camera head board (circuit board 31), circuit components controlling the camera head and the like are mounted.

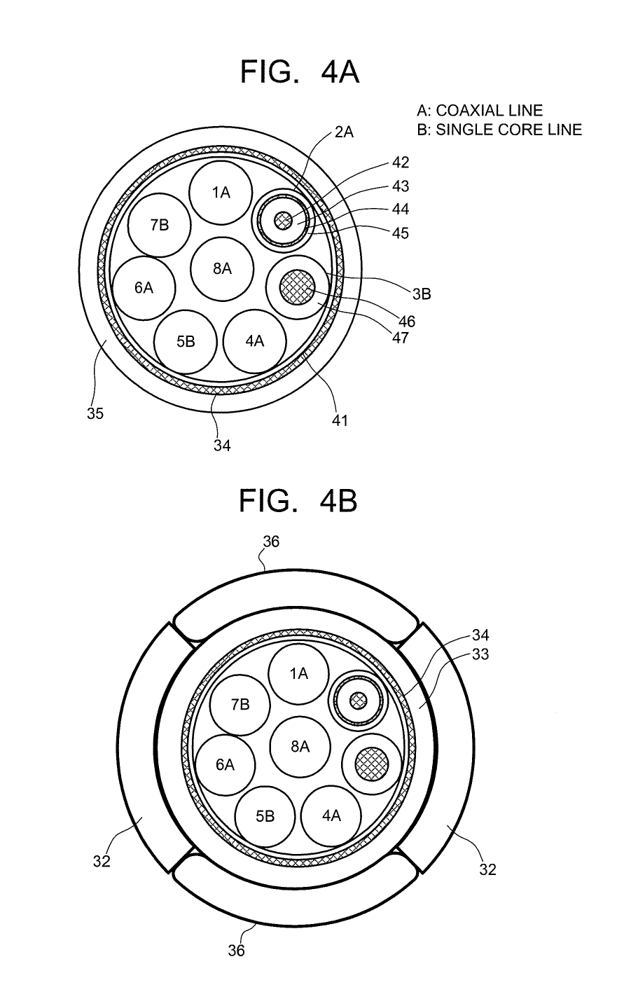

FIG. 4A is a sectional diagram taken along A-A in FIG. 3B. FIG. 4B is a sectional diagram taken along B-B in FIG. 3B.

As illustrated in FIG. 4A, the cable bundle includes a plurality of cables such as coaxial cables 1A, 2A, 4A, 6A, 8A and single core cables 3B, 5B, 7B.

For example, these plurality of cables are bundled by a fixing tape 41. To an upper surface on the outside of the fixing tape 41, the jacket 35 with high insulation performance is provided.

To an upper surface on the outside of the shielding part 34, the jacket 35 of the cable bundle with high conductivity and high electromagnetic shield effect is provided. Specifically, the cable bundle is formed of an aggregate of multiple cores of the coaxial cables, insulated wires and the like. The cable bundle is arranged using the fixing tape, and then forms a shielding part formed of the shielding part 34 of the cable bundle. Further, the cable bundle has a structure in which it is covered by the insulating jacket (the jacket 35 of the cable bundle).

As illustrated in FIGS. 3A and 3B and FIG. 4B, the shielding part 34 of the cable bundle is “crimped” by the supporting member 33 to be fixed. The supporting member 33 is desirably formed of the material with good conductivity as described above, and uses a copper alloy, for instance.

Further, in this case, the conductive adhesive 36 is coated on the supporting member 33 and the shielding part 34 of the cable bundle, as illustrated in FIG. 3B and FIG. 4B. Further, although not illustrated in particular, each core of the plurality of cables is soldered to the circuit board 31.

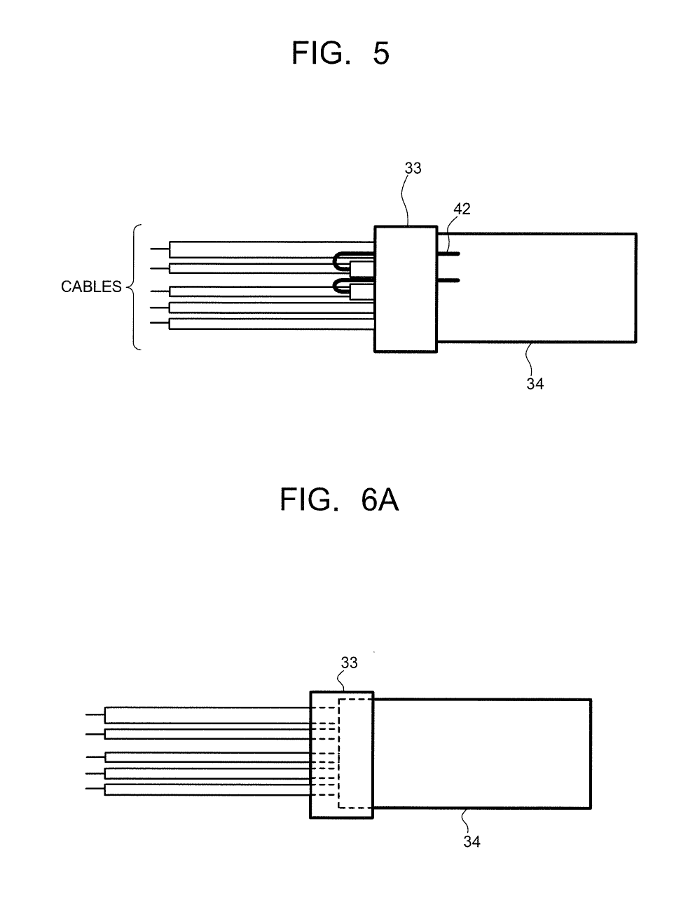

FIG. 5 is a diagram explaining the supporting member of the camera head used in the imaging apparatus of the embodiment. As described above, the shielding part 34 of the cable bundle is “crimped” by the supporting member 33 to be fixed. Further, in this embodiment, a shielding 44 and the like of the coaxial cable 2A and the like are folded back, and electrically brought into contact with the shielding part 34 of the cable bundle to be connected to GND, for example.

At this time, the supporting member 33 can support the shielding 44 while keeping the small size of the camera head.

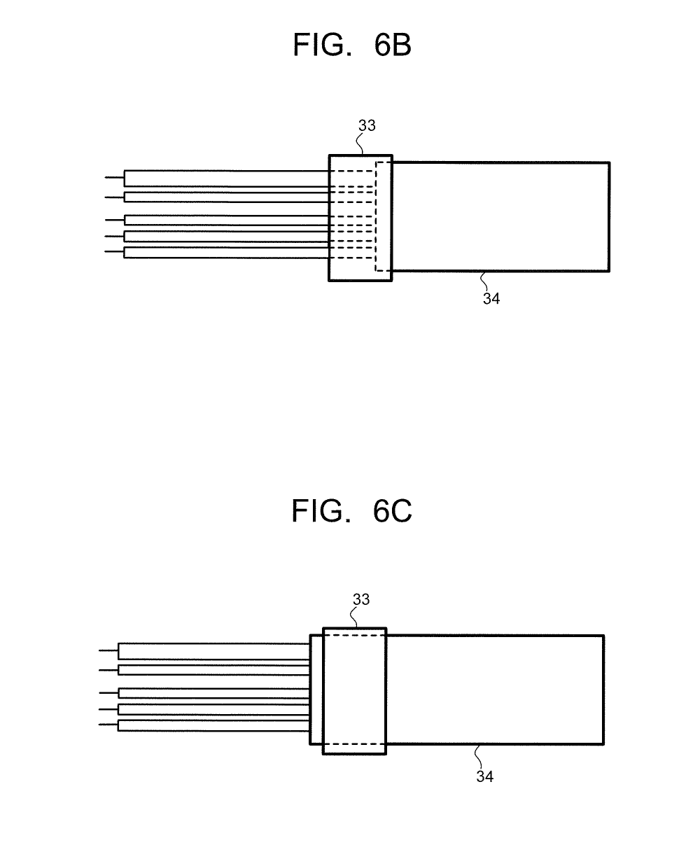

FIG. 6A to FIG. 6C are diagrams illustrating examples of mounting method of the camera head used in the imaging apparatus of the embodiment.

FIG. 6A illustrates a state where the supporting member 33 supports, with a part thereof, the shielding part 34 of the cable bundle.

FIG. 6B illustrates a state where the supporting member 33 supports, with a smaller part thereof, the shielding part 34 of the cable bundle, compared to FIG. 6A.

FIG. 6C illustrates a state where the shielding part 34 of the cable bundle protrudes from the supporting member 33, and the supporting member 33 supports, under this state, the shielding part 34 of the cable bundle.

As described above, in this embodiment, the supporting member 33 is only required to support the shielding part 34 of the cable bundle, and does not always have to strongly “crimp” the shielding part 34.

Specifically, in this embodiment, the camera head of the imaging apparatus includes the conductive supporting member 33 provided to be electrically brought into contact with the shielding part 34 of the cable bundle, and supporting the cable bundle.

Further, the camera head includes the supporting member holding part (metallic frame) 32 provided to support the circuit board 31 controlling the imaging element 17, and holding the conductive supporting member 33. Besides, the supporting member holding part (metallic frame) 32 is connected to a part of the cables of the cable bundle.

The camera head includes the conductive coating member (conductive adhesive) 36 coated on a part of the supporting member 33 and a part of the supporting member holding part (metallic frame) 32.

As described above, in this embodiment, the adhesive in which the material with good conductivity such as silver powder, copper powder, carbon fiber or the like is mixed, can be used as the conductive coating member.

Further, in the supporting member holding part 32, the metallic material is included, as described above.

A part of the cables included in the cable bundle is supported by the conductive supporting member 33, and electrically connected to the shielding part 34 of the cable bundle.

Further, the conductive supporting member 33 may also practically “crimp” the cable bundle.

As described above, in this embodiment, the supporting member 33 supports the shielding part 34 of the cable bundle. Further, the conductive adhesive 36 is designed to be coated on the contact portion between the supporting member 33 and the metallic frame 32.

Through the configuration as above, it becomes possible to prevent the adhered portion from being peeled off from the contact portion between the supporting member 33 and the metallic frame 32 on which the conductive adhesive 36 is coated, when the cable bundle is bent.

For example, by fixing the conductive adhered portion between the metallic frame 32 and the shielding part 34 of the cable bundle (conductive adhesive 36) using the conductive material such as the supporting member 33, it becomes possible to prevent the deterioration of the conductive adhered portion (conductive adhesive 36) caused by bending the cable.

Accordingly, in the endoscope camera of the head separation type, it becomes possible to reduce the size of the camera head.

While certain embodiments have been described, these embodiments have been presented by way of example only, and are not intended to limit the scope of the inventions. Indeed, the novel embodiment described herein may be embodied in a variety of other forms; furthermore, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera head, comprising:
a conductive supporting member configured to be provided to be electrically brought into contact with a shielding part of a cable bundle, and configured to support the cable bundle;
a supporting member holding part configured to be provided to support a circuit board controlling an imaging element, and configured to hold the conductive supporting member configured to be connected to a part of cables of the cable bundle; and
a conductive coating member configured to be coated on a part of the supporting member and a part of the supporting member holding part.

2. The camera head according to claim 1, further comprising the imaging element.

3. The camera head according to claim 1,
wherein the conductive supporting member configured to include a metal.

4. The camera head according to claim 1,
wherein the supporting member holding part configured to include a metal.

5. The camera head according to claim 1,
wherein a part of the cables included in the cable bundle configured to be supported by the conductive supporting member, and electrically connected to the shielding part of the cable bundle.

6. The camera head according to claim 1,
wherein the conductive supporting member configured to practically crimp the cable bundle.

7. An imaging apparatus, comprising:
the camera head according to claim 1; and
a CCU configured to control the camera head and output an image signal.
